(19) United States
(12) Patent Application Publication
(10) Pub. No.: US 2009/0000568 A1
(43) Pub. Date: Jan. 1, 2009

(54) Shock Absorbing Leash Attachment

(76) Inventors: Joshua Harrison Titcomb, Delray Beach, FL (US); Megan Elizabeth Murdoch, Delray Beach, FL (US)

Correspondence Address: Elizabeth Murdoch, 774 Azalea Street, Boca Raton, FL, 33486, US

(21) Appl. No.: 12/143,800

(22) Filed: Jun. 22, 2008

Related U.S. Application Data
(60) Provisional application No. 60/937,382, filed on Jun. 28, 2007.

(51) Int. Cl. A01K 27/00

(52) U.S. Cl. 119/798

(57) ABSTRACT

A shock absorbing leash attachment comprising an elastic member around which a common animal tether or leash is spirally wound, the two ends of the tether or leash passing through openings at each end of the elastic member respectively. Shock on the tether or leash is absorbed by straining the elastic member in torsion and tension.

### BACKGROUND OF THE INVENTION

1. Technical Field

The present invention generally relates to shock absorbing line attachments, and in its preferred embodiments more specifically relates to a shock absorbing attachment for animal tethers and leashes.

2. Background Art

The walking of an animal on a leash is a common practice, as is the tethering of an animal to an immovable object for the purpose of allowing it to move around while not being able to leave a designated area. Sudden movements by the animal may cause a substantial shock to the animal, and in the case of walking with a leash, to the animal's handler as well. A conventional tether or leash provides no shock-absorption for either animal or handler to cushion or absorb these shocks.

Elastic leashes and leashes with elastic portions have been created in an effort to remedy this problem, but they must be used instead of any leash already owned by the handler, and force the handler to sacrifice control. Without grasping the animal's harness or collar directly, the elasticity is ever-present, not allowing the handler to correct the animal using the conventional method of a sharp tug on the leash. Additionally, these leashes are designed only for walking and do not address the problem that still exists when tethering the animal to an immovable object.

Elastic leash couplers have been created to allow for use with a leash already owned by the handler, but they suffer from the same control problem as elastic leashes, because they are attached between the leash and the collar. Additionally, these couplers have another drawback in that no matter how strong the original leash or tether is, once the elastic coupler is attached the entire leash or tethering system will be only as strong as the elastic coupler.

There remains a need for an elastic attachment that can easily be used with an already owned leash or tether, that will not weaken the link formed by the leash or tether, and that will not reduce a handler's ability to control and correct an animal.

### BRIEF SUMMARY OF THE INVENTION

In accordance with the invention there is provided an elongate elastic member having openings at each of its two ends, wherein a tether or leash can pass through one of said openings, winding spirally around the elastic member before passing through the opening at the opposite end.

The present invention can be easily applied to a commercially available leash or one already owned by an animal handler, with no special skill required, and while retaining the look and style of the original leash. The present invention can also be easily attached to a tether, sometimes called a tie-out. The present invention can be removed from a leash or tether at any time, without damaging either the present invention or the leash or tether.

When the present invention is properly attached to a leash or tether, a section of the leash or tether becomes substantially elastically stretchable, and is able to absorb shocks created by sudden movements at either end of the leash or tether.

Unlike elastic leash couplers in the prior art, whether using the present invention with a leash or a tether, no weakening of the link created by the leash or tether will occur. If the present invention fails in any way, and for any reason, the leash or tether will continue to function just as it would if the present invention were not used.

Unlike elastic leashes, leashes with elastic portions, and elastic leash couplers in the prior art, the present invention can be used to make any portion of a leash substantially elastic. Thus, the present invention can be attached to a leash closer to the end held by a handler than the end linked to an animal's collar. In doing so, the handler is still able to hold the leash in between the portion made elastic by the present invention and the animal's collar. Thus, the handler can still have the same amount of control that would be provided by the same leash when the current invention is not attached, and can still correct an animal with sharp tugs, or allow the present invention to absorb some of the shock of correcting tugs, at the handler's own discretion.

The structure and features of the preferred embodiments of the present invention will be described in more detail with reference to the accompanying drawing figures.

### BRIEF DESCRIPTION OF THE SEVERAL VIEWS OF THE DRAWINGS

FIG. 1 is a top elevation of a preferred embodiment in an un-stretched state.

FIG. 2 is a top elevation of a preferred embodiment in an un-stretched state and attached to a leash.

FIG. 3 is a side elevation of a preferred embodiment in an un-stretched state and attached to a leash.

FIG. 4 is a top elevation of a preferred embodiment in a stretched state.

FIG. 5 is a top elevation of a preferred embodiment in a stretched state and attached to a leash.

FIG. 6 is a perspective view of a preferred embodiment attached to a leash closer to the end held by a handler than the end linked to an animal's collar.

### DETAILED DESCRIPTION OF THE INVENTION

It is to be understood that the terminology used herein is for the purpose of describing particular embodiments of the invention only and is not intended to be limiting.

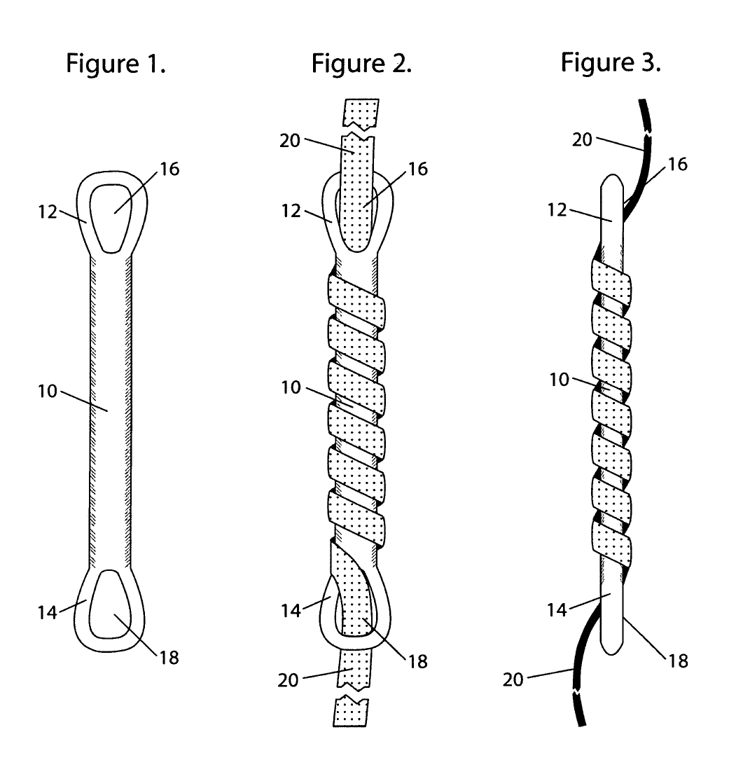

Referring now to FIG. 1, there is shown an elongate elastic member 10, having a first flange 12 projecting parallel with the axis of elastic member 10 at one end and a second flange 14 projecting parallel with the axis of elastic member 10 at the other end. Each flange is perforated to form a first eyelet 16 and a second eyelet 18. Elastic member 10 is shown in an un-stretched state.

Preferred materials for elastic member 10 are rubber or elastomer, bungee or shock cord, elastic fabric, metal coil spring enclosed in a stretchable tubular housing, woven rubber strands, or any sufficiently elastic, strong and light material or combination of materials. The most preferred material for elastic member 10 is rubber or elastomer.

Preferred materials for the flanges 12 and 14 are a continuation of the material of elastic member 10, or any sufficiently strong and light material or combination of materials that can be permanently bonded to the elastic member. The most preferred material for the flanges 12 and 14 is a continuation of the material of elastic member 10.

Some presently preferred sizes or dimensions are given herein for the purpose of illustration, and not for the purpose of limitation. A preferred length for elastic member 10 may be approximately 6-14 inches. A preferred width or diameter for elastic member 10 may be 0.25-0.75 inches.

Referring now to FIGS. 2 and 3, there is shown a leash 20 passing through eyelet 16, spirally wound around elastic member 10, and then passing through eyelet 18. Eyelets 16 and 18 should be large enough in diameter to allow at least one end of leash 20 to pass through. If flanges 12 and 14 are made of a stretchable material, eyelets 16 and 18 may be too small in diameter to allow either end of leash 20 to pass through, provided at least one end of leash 20 can pass through said eyelets when said flanges are stretched. By spirally winding leash 20 around elastic member 10, elastic member 10 is caused to substantially retain its position on leash 20 by friction. Because elastic member 10 is held in place on leash 20 by friction, eyelets 16 and 18 do not need to attach to or grip leash 20, as long as leash 20 can pass through said eyelets.

Leash 20 is spirally wound around elastic member 10 six times for the purpose of illustration, and not for the purpose of limitation. The number of times a leash or tether may be spirally wound around elastic member 10 during actual use of the present invention depends upon several factors including the exact dimensions of elastic member 10, the width or diameter of the leash or tether, and the difference between the un-stretched length of elastic member 10 and the maximum length to which elastic member 10 can be elastically stretched.

Leash 20 is shown for the purpose of illustration, and not for the purpose of limitation. Any suitable leash or tether could be used with the present invention in place of leash 20.

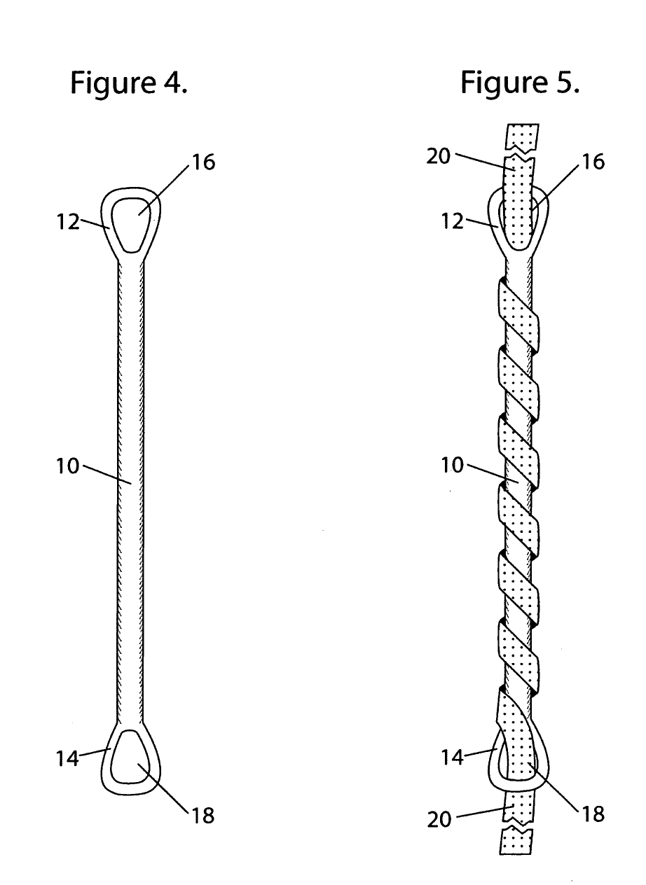

Referring now to FIG. 4, there is shown the same preferred embodiment as shown in FIG. 1, but in an elastically stretched state. Elastic member 10 should preferably be elastically stretchable to between 150% and 200% of its un-stretched length.

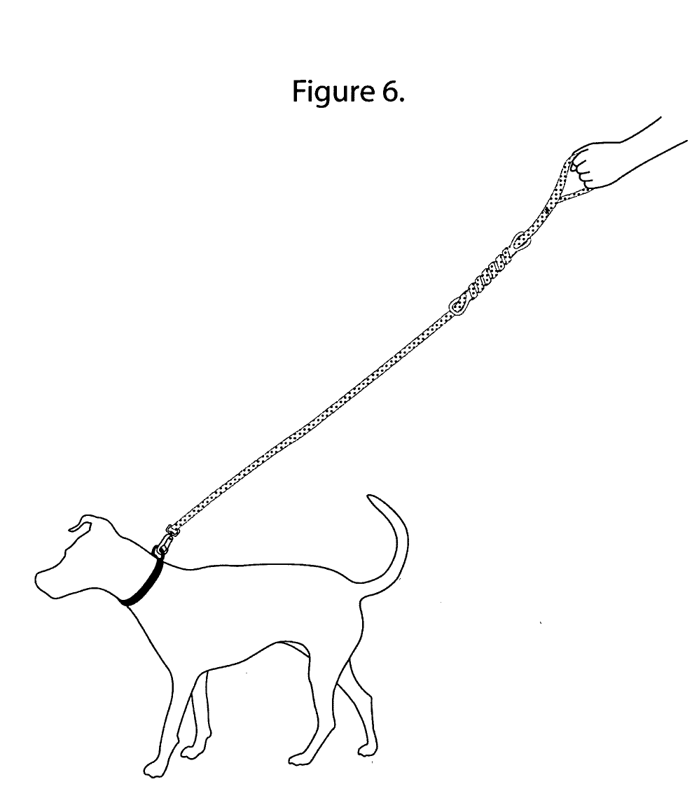

Referring now to FIG. 5, there is shown the same preferred embodiment attached to leash 20 as shown in FIGS. 2 and 3, but in an elastically stretched state. Illustrated in FIG. 5 is the effect on leash 20 caused by stretching elastic member 10. The coil formed by the spiral winding of leash 20 illustrated in FIGS. 2 and 3 is elongated by straining elastic member 10 in torsion and tension. The overall length of leash 20 is at first shortened by spirally winding it around elastic member 10, but when elastic member 10 is stretched as shown in FIG. 5, the overall length of leash 20 approaches the original length of leash 20 when the present invention is not attached.

Referring now to FIG. 6, there is shown an illustration of a typical leash, held at one end by a handler and linked at the other end to a dog's collar. The present invention is attached to the leash, closer to the end held by the handler than the end linked to the collar. The present invention is shown in an un-stretched state, making the overall length of the leash shorter than the leash's original length. The dog, handler, and leash shown in FIG. 6 are shown for the purpose of illustration, and not for the purpose of limitation.

What is claimed is:

1. A shock absorbing leash attachment, comprising a first end portion, a second end portion, and a central portion, said end portions each comprising an opening through which a sufficiently thin flexible line can pass, and said central portion comprising an elongate elastic member, wherein said elastic member is capable of elastically stretching from an un-stretched first length to a desired second length.

2. The leash attachment of claim 1, wherein said end portions comprise elastomeric flanges, said flanges each being perforated to form an eyelet.

3. The leash attachment of claim 1, wherein said end portions comprise rigid rings.

4. The leash attachment of claim 1, wherein said end portions each comprise straps having hooks and loops, said straps being able to be temporarily connected to form a closed loop around said flexible line.

5. The leash attachment of claim 1, further comprising an internal limiting member, said limiting member attaching to both said end portions and being substantially free from strains when said leash attachment is at said first length.

6. The leash attachment of claim 5, wherein said limiting member is a monofilament nylon line or other suitable strong line similar to monofilament line.

7. The leash attachment of claim 5 wherein said limiting member is configured to prevent extension of said elastic member beyond said second length.

8. A method for reducing shock between a first and second object comprising the steps of:
providing a shock absorbing leash attachment, comprising a first end portion, a second end portion, and a central portion, said end portions each comprising an opening through which a sufficiently thin flexible line can pass, and said central portion comprising an elongate elastic member, wherein said elastic member is capable of elastically stretching from an un-stretched first length to a desired second length; and
passing a sufficiently thin flexible line through the opening in said first end portion, spirally winding said flexible line around said elastic member, and then passing said flexible line through the opening in said second end portion;
so that the amount of shock transmitted to the first and second object when they are moved away from each other is reduced.

9. The method of claim 8, wherein the first object comprises an animal.

10. The method of claim 9, wherein the second object comprises another animal.

11. The method of claim 9, wherein the second object comprises a person.

12. The method of claim 9, wherein the second object comprises an inanimate object.
